(19) United States
(12) Patent Application Publication
(10) Pub. No.: US 2024/0239267 A1
(43) Pub. Date: Jul. 18, 2024

(54) ACTUATOR FOR EXTERIOR VEHICULAR COMPONENT

(71) Applicant: Magna Mirrors of America, Inc., Holland, MI (US)

(72) Inventors: Anthony J. LaCross, Hastings, MI (US); Connor G. Cervone, Byron Center, MI (US); Timothy W. Condron, Canton, MI (US); Kenneth C. Peterson, Ada, MI (US)

(21) Appl. No.: 18/414,533

(22) Filed: Jan. 17, 2024

Related U.S. Application Data
(60) Provisional application No. 63/480,360, filed on Jan. 18, 2023.

(51) Int. Cl. B60R 1/074; E05B 85/10; F16D 11/10

(52) U.S. Cl. CPC B60R 1/074; E05B 85/107; F16D 11/10

(57) ABSTRACT

A vehicular exterior rearview mirror assembly includes a mirror head that is movable relative to a mounting base and a powerfold actuator that is operable to move the mirror head relative to the mounting base between a folded position and an extended position. The powerfold actuator includes a base portion attached at the mounting base and a pivot tube that extends from the base portion through an output gear and a housing. The output gear includes a plurality of detents that engage a corresponding plurality of detents of the housing. With the detents engaged, a biasing element biases through the housing and the output gear to the base portion to releasably retain the powerfold actuator in the at least one detent state of the powerfold actuator. With the detents disengaged, the biasing element does not bias through the housing and the output gear.

### CROSS REFERENCE TO RELATED APPLICATION

The present application claims the filing benefits of U.S. provisional application Ser. No. 63/480,360, filed Jan. 18, 2023, which is hereby incorporated herein by reference in its entirety.

### FIELD OF THE INVENTION

The present invention relates generally to the field of exterior components for vehicles and, more particularly, to rearview mirror assemblies, powerfold exterior rearview mirror assemblies, and door handles for opening a side door and/or liftgate of a vehicle.

### BACKGROUND OF THE INVENTION

It is known to provide a vehicular exterior rearview mirror assembly that includes a foldable mirror assembly, such as a powerfold mirror where the mirror head is pivotable via an actuator between a drive or use position and a folded or park position.

### SUMMARY OF THE INVENTION

An exterior rearview mirror assembly for a vehicle may include a mirror head that includes a mirror reflective element. A mounting base is configured for attachment at a side of the vehicle. The mirror head is movable relative to the mounting base between at least an extended position, where the mirror head is extended outward from the side of the vehicle so that the mirror reflective element is positioned to provide a rearward view at the side of the vehicle to a driver of the vehicle, and a folded position, where the mirror head is moved inward from the extended position toward the side of the vehicle. A powerfold actuator is electrically operated to move the mirror head relative to the mounting base between the folded position and the extended position. The powerfold actuator includes a base portion that attaches at the mounting base and a pivot tube that extends from the base portion. The pivot tube extends through an output gear of the powerfold actuator and a housing of the powerfold actuator. The mirror head is attached at the housing of the powerfold actuator, and the mirror head and the housing of the powerfold actuator, when the powerfold actuator is electrically operated, move together and in tandem about a longitudinal axis of the pivot tube of the powerfold actuator. The output gear is rotatably fixed relative to the base portion, and the housing of the powerfold actuator, when the powerfold actuator is electrically operated, pivots about the output gear as the housing moves about the longitudinal axis of the pivot tube of the powerfold actuator. The powerfold actuator includes a biasing element disposed between the housing of the powerfold actuator and an upper end of the pivot tube, and the biasing element releasably retains the powerfold actuator in at least one detent state of the powerfold actuator. The output gear includes a plurality of detents that, when the powerfold actuator is in the at least one detent state of the powerfold actuator, engages a corresponding plurality of detents of the housing of the powerfold actuator. The plurality of detents of the housing, as the mirror head moves between the extended position and the folded position, disengage from the plurality of detents of the output gear and move between the plurality of detents of the output gear. With the plurality of detents of the output gear engaged with the corresponding plurality of detents of the housing of the powerfold actuator, a spring load of the biasing element is through the housing and the output gear to the base portion to releasably retain the powerfold actuator in the at least one detent state of the powerfold actuator. With the plurality of detents of the housing disengaged from the plurality of detents of the output gear, the spring load of the biasing element is not through the housing and the output gear.

Optionally, an actuator may be configured to move (e.g., pivot or rotate or extend) any suitable vehicular component, such as a handle portion of a vehicular door handle assembly or the mirror head of the mirror assembly. Optionally, the actuator is configured to provide a variable torque output that mechanically adjusts between a low speed, high torque output and a high speed, low torque output. The actuator may adjust based on the torque load at an output element of the actuator. Optionally, a clutch assembly may be coupled to the actuator to selectably adjust between the high torque output and the low torque output.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle equipped with a powerfold exterior rearview mirror assembly and a door handle assembly;

FIG. 2 is a view of the exterior rearview mirror assembly disposed at the side of the vehicle;

FIG. 3 is a view of the exterior rearview mirror assembly in an extended or use position;

FIG. 4 is a view of the exterior rearview mirror assembly pivoted from the extended position to a folded or non-use position;

FIG. 5 is a sectional view of an actuator electrically operable to pivot the mirror head between the extended and folded positions;

FIG. 6 is a perspective view of an upper housing of the actuator of FIG. 5;

FIGS. 7 and 8 are perspective views of a lower detent element of the actuator of FIG. 5;

FIGS. 9 and 10 are perspective views of an output gear of the actuator of FIG. 5;

FIG. 11 is a sectional view of the actuator of FIG. 5 with the mirror head in the folded position;

FIG. 12 is a sectional view of the actuator of FIG. 5 with the mirror head between the folded and extended positions;

FIG. 13 is a partial sectional view of an actuator that is electrically operable to move a handle portion of the door handle assembly from a recessed position to an extended position;

FIGS. 14-16 are views of the motor and gear train of the actuator of FIG. 13;

FIG. 17 is an exploded view of the actuator of FIG. 13;

FIG. 18 is an enlarged view of a portion of the gear train of the actuator of FIG. 13;

FIG. 18A is a sectional view of the gear train of the actuator, taken along the line A-A of FIG. 18;

FIG. 19 is an exploded view of a variable torque clutch assembly;

FIG. 20 is a perspective view of a high torque output gear element of the clutch assembly of FIG. 19;

FIG. 20A is an enlarged view of area A of FIG. 20;

FIGS. 21 and 22 are views of the clutch assembly of FIG. 19;

FIG. 23 is a perspective view of the clutch assembly of FIG. 19, with the input element and housing made transparent; and

FIG. 24 shows an example control function for a vehicular actuator.

### DESCRIPTION OF THE PREFERRED EMBODIMENTS

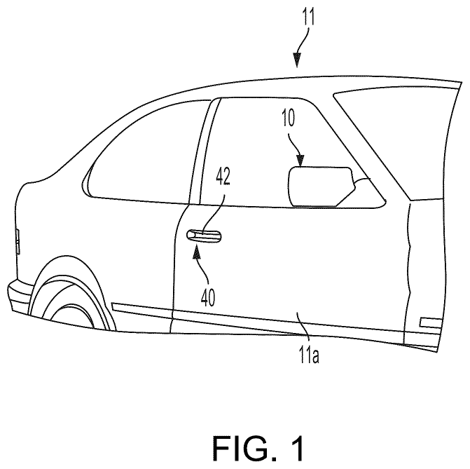

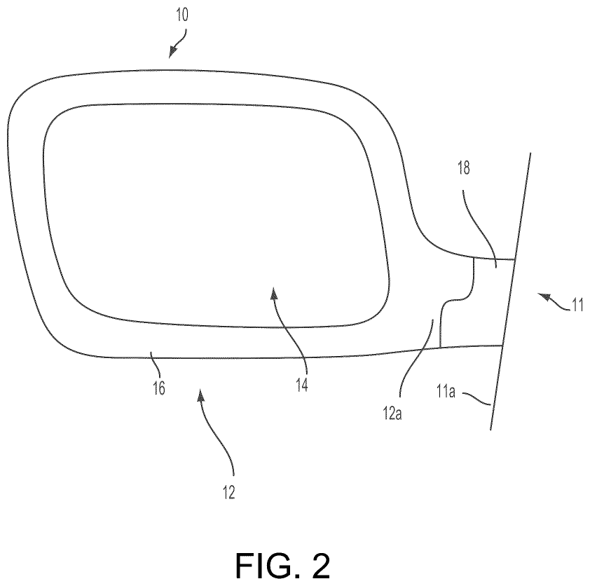

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIGS. 1 and 2). The mirror head portion 12 includes a mounting portion 12a that is pivotally or movably mounted to a mounting arm or base or portion 18. The mirror assembly 10 comprises a powerfold mirror (where the mirror head portion may be pivoted via an actuator assembly or adjustment device), and may comprise a breakaway mirror (where the mirror head portion may be manually pivoted about the mounting arm or base). The mounting arm or base 18 of the mirror assembly 10 is mounted at the side 11a of a host or subject vehicle 11 equipped with the mirror assembly 10, with the reflective element 14 providing a rearward field of view along the respective side of the vehicle to the driver of the vehicle.

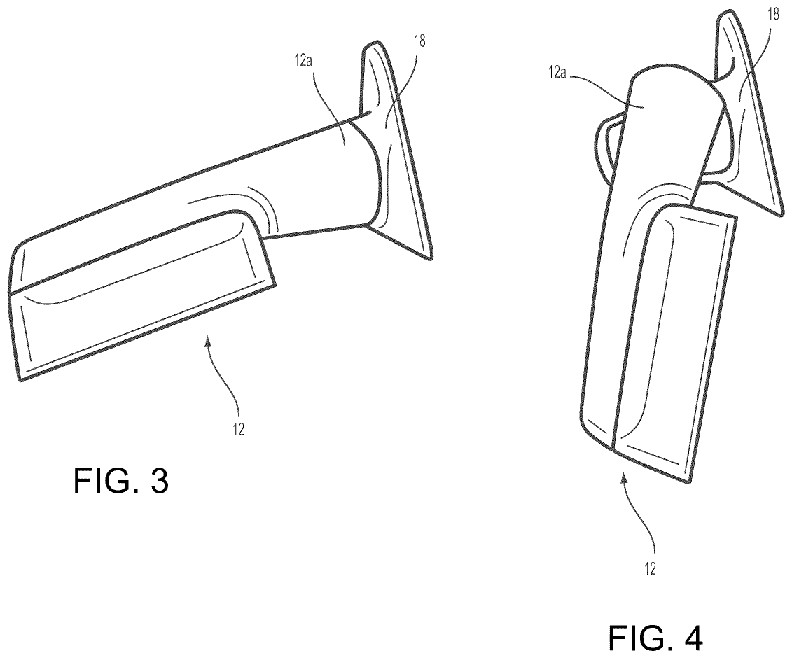

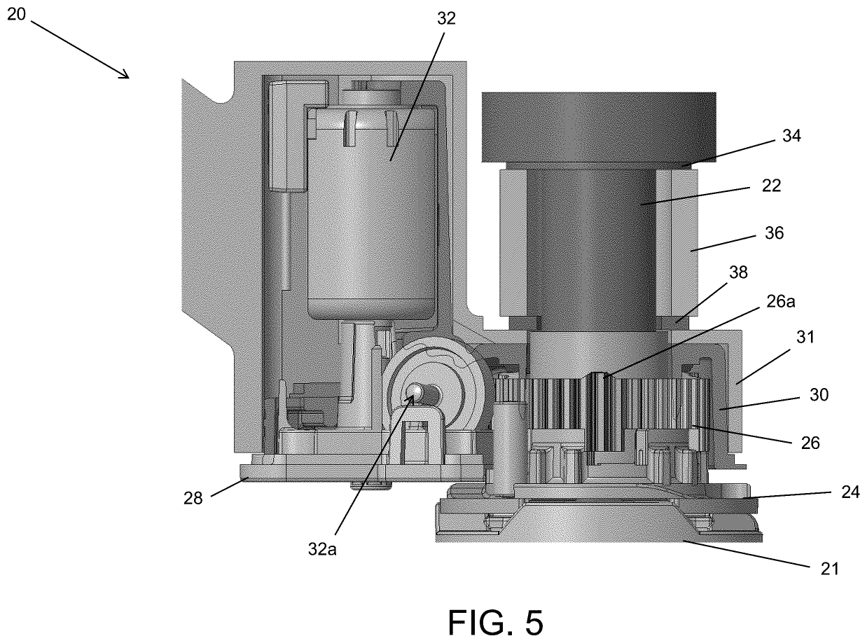

The powerfold mirror assembly 10 includes an actuator 20 (FIG. 5) that is electrically operable to pivot the mirror head 12 (comprising the mirror casing 16 and reflective element 14) relative to the mounting arm or base 18. The actuator 20 operates, such as responsive to a user input, to pivot the mirror head 12 between a plurality of detent positions, including a use or drive or extended position (FIG. 3) and a folded or park position (FIG. 4). The mirror head is also pivotable manually to either the use or folded position. The actuator may pivot the mirror head 12 between the use position and the folded position responsive to the user input, or the actuator may pivot the mirror head automatically, such as upon completion of performance of a parking maneuver of the vehicle or upon locking or unlocking of the doors of the vehicle.

When in the use or drive position, the mirror head 12 is extended from the side 11a of the vehicle 11 so as to provide the rearward field of view along the side of the vehicle to the driver of the vehicle. When in the folded or park position, the mirror head 12 is folded or pivoted or rotated from the extended position toward the side 11a of the vehicle 11, such that the mirror reflective element 14 may be facing the side of the vehicle and does not provide the rearward field of view along the side of the vehicle. Optionally, the mirror head 12 may also be pivoted to a fully forward position, where the mirror head 12 is folded or pivoted or rotated away from the folded position and beyond the use position, such that the mirror reflective element 14 may face sideward or forward away from the side 11a of the vehicle 11. The mirror head 12 may pivot toward the fully forward position manually, such as upon contact or a collision with an object. A seal may be disposed along the interface between the mounting portion 12a of the mirror head 12 and the mounting arm or base 18, such as to reduce noise or damage from vibration of the mirror head 12 relative to the mounting base 18 and/or to preclude moisture or debris from entering the mirror head 12 or mounting base 18.

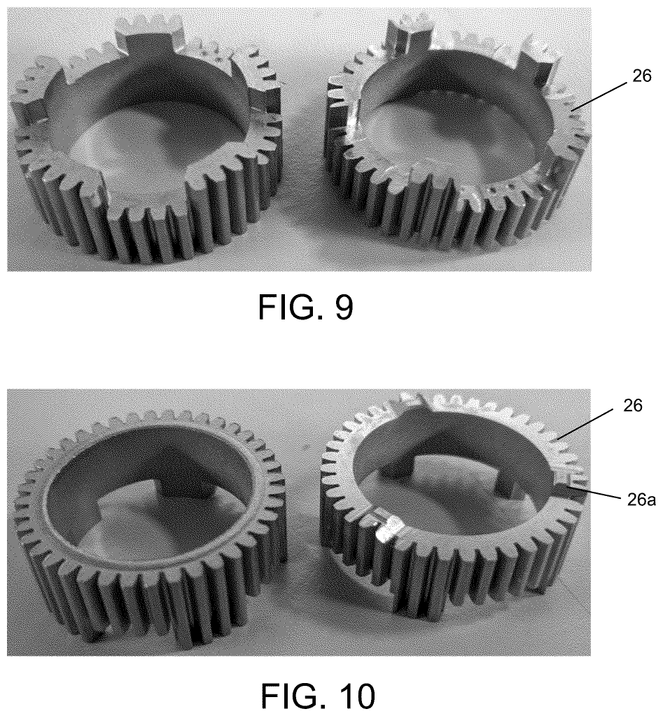

As shown in FIGS. 5-12, the actuator 20 comprises a pivot assembly that has a base post construction that is fixedly disposed at or attached at the mounting base 18 and that has a pivot tube or post 22 and a base 21 integrated together (or that has a separate base and pivot post joined together) with the pivot post 22 providing or defining a pivot axis for the mirror head 12 when the mirror head 12 is moved between the extended position, the folded position, and the fully forward position. The post 22 extends from the base 21 and extends through a lower detent plate 24 (FIGS. 7 and 8) and an output gear 26 (FIGS. 9 and 10) that are disposed at the post 22. The lower detent 24 and the output gear 26 are keyed together and non-rotatable relative to one another, and the lower detent 24 and the output gear 26 may be rotatable together and in tandem relative to the post 22 and the base 21 when the mirror head 12 is manually pivoted.

An actuator housing or bracket, comprising a lower housing 28 and an upper housing 30, is rotatably disposed at the post 22 and houses one or more electrically operable motors 32 that, when electrically operated, cause the actuator housing to rotate or pivot about the post 22. The actuator housing is non-rotatably disposed or attached at the mirror head 12 so that movement or rotation of the actuator housing about the pivot axis of the pivot post 22 translates to movement or rotation of the mirror head 12. Thus, the one or more motors 32 are actuated to pivot or rotate the actuator housing, and therefore the mirror head 12, about the pivot axis. Optionally, a mounting bracket 31 is disposed at the housing for mounting the housing to the mirror head.

The one or more motors 32 are actuated to rotatably drive a gear train 32a, which engages the output gear 26 and rotates or pivots the housing relative to the output gear 26 until a hard stop is engaged (such as with the mirror head at the extended position), whereby the motor will stall or stop, with the mirror head 12 retained at the extended or drive position via detent elements or engagements or states of the actuator. The actuator 20 is configured such that a hard stop is provided at the appropriate locations when the mirror head 12 is pivoted via driving of the motor to position the mirror head as desired, such as at the folded position and at the use position.

The post 22 extends from the base 21 and through the lower detent or detent plate 24 and the output gear 26. The lower detent 24 may be disposed between the lower housing 28 and the base 21 and engage the output gear 26 through an aperture of the lower housing 28. The upper housing portion 30 attaches to the lower housing 28 and encloses a portion of the post 22, the motors 32 and gear train 32a, the output gear 26, and at least a portion of the lower detent 24. The output gear 26 and the lower detent plate 24 are keyed together and do not rotate or move relative to one another. The output gear 26 and lower detent 24 do not rotate relative to the post 22 during electric actuation of the actuator 20 via operation of the motors 32. The actuator may utilize aspects of the actuators described in U.S. Pat. Nos. 7,887,202; 9,487,142; 11,396,264 and/or 9,067,541, and/or U.S. Publication Nos. US-2020-0223364; US-2021-0261053 and/or US-2022-0126751, and/or International Publication No. WO 2019/035078, which are all hereby incorporated herein by reference in their entireties.

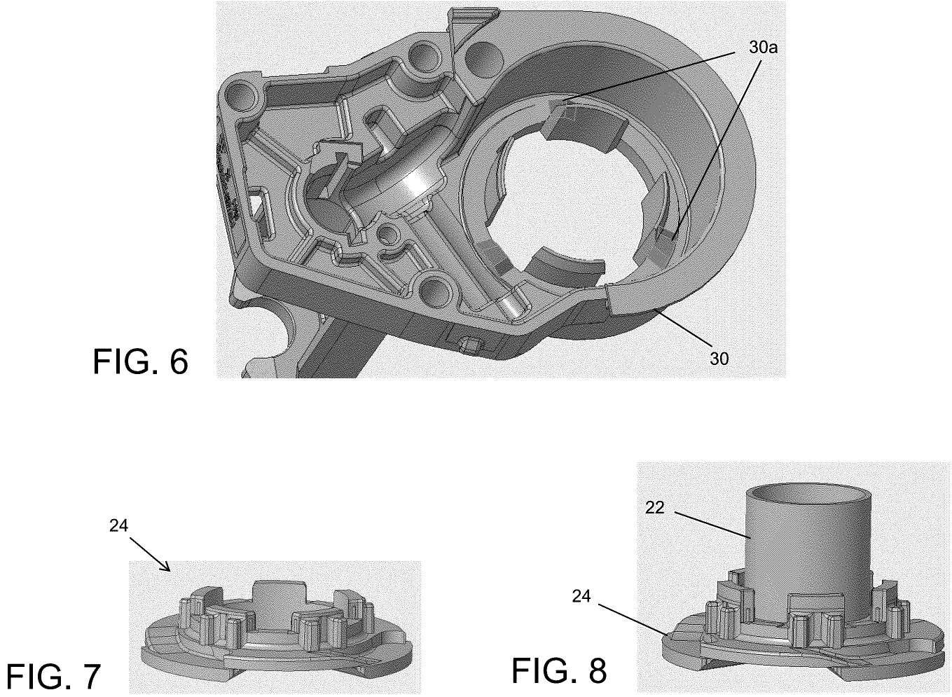

A lower end or surface of the output gear 26 is keyed to the detent plate 24 to rotatably fix the output gear 26 relative to the detent plate 24. An upper end or surface of the output gear 26 (i.e., a detent surface) includes a plurality of protrusions or detents 26a disposed circumferentially along the upper surface. The detents 26a of the output gear 26 are configured to engage respective detents 30a along an inner detent surface of the upper housing 30 that faces the output gear 26 (FIG. 6).

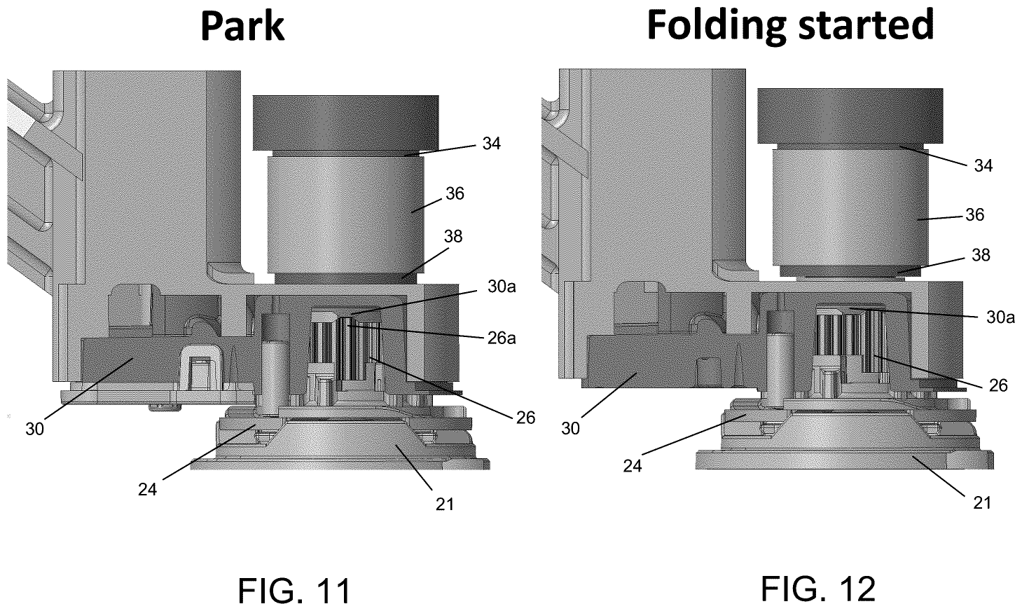

As shown in FIG. 11, when the mirror head is in the folded or park position (or when the mirror head is in the extended or use position), and the actuator is in a detent position, the detents 26a of the output gear 26 engage the detents 30a of the upper housing 30 to cinch the actuator 20. In other words, the respective detent surfaces of the output gear 26 and upper housing 30 engage one another so that, when the actuator is in a detent position, the output gear and upper housing 30 are urged away from one another along the pivot post 22 via engagement of the detent surfaces to secure the actuator in the detent position.

For example, a retainer 34 (FIGS. 11 and 12) may be rigidly fastened to the post 22 or integrally formed as a flared end of the post, such that the retainer 34, post 22 and base 21 are effectively a single member or element and provide axial and rotational ground reference for all motions and forces. A spring or biasing element 36, such as a coil spring, may be disposed between the retainer 34 and an upper surface of the upper housing 30 and urge or bias the actuator housing downward along the post 22 toward the output gear 26 and base 21. The spring 36 (or other suitable biasing or urging element) may provide the primary load and exert a downward force at the upper housing 30, to bias the actuator housing toward the lower detent 24 and the base 21, so that the actuator housing engages the base 21, via the output gear 26 and detent plate 24. Thus, when the actuator 20 is in a detent position (e.g., FIG. 11) and the detents 26a of the output gear 26 engage respective detents 30a of the upper housing 30, the upper housing 30 moves upward along the pivot post 22 against the biasing force of the spring 36 and the actuator is cinched or secured in the detent position. The spring load of the biasing element 36 is through the housing and the output gear 26 to the lower detent plate 24 and base 21 to retain the mirror head in the detent position.

When the mirror head is moved from the folded or extended position and the actuator 20 is moved out of the detent position, the detents of the output gear 26 and upper housing 30 disengage and the upper housing 30 moves along the post 22 toward the output gear 26 (FIG. 12). As the actuator housing pivots about the output gear 26, the detents 30a of the upper housing 30 travel along the upper surface of the output gear 26 between respective detents 26a so that the actuator housing is lower along the pivot post 22 (i.e., closer to the base 21) than when in the detent position.

The lowered position of the actuator housing along the pivot post 22 during pivoting of the mirror head reduces or eliminates the spring load on the actuator housing as the mirror head pivots between detent positions, and increases the mechanical life of the actuator and electrical life of the motor 32. That is, the actuator housing drops during travel of the mirror head to relieve spring load during travel, and the detent surfaces allow the actuator to rise along the pivot post and cinch properly in the detent positions.

Optionally, the spring load may transfer to the pivot tube 22 when the detents 26a of the output gear 26 and the housing disengage. That is, a washer or lower spring retainer 38 may be disposed along the pivot tube 22 between the biasing element 36 and the upper surface of the upper housing 30. The lower spring retainer 38 may define a lower limit of the biasing element 36 so that, when the detent surfaces disengage and the actuator housing drops along the pivot post 22, the actuator housing disengages from the biasing element 36 entirely and no spring load acts on the actuator housing as the mirror head pivots (FIG. 12). When the detent surfaces of the output gear 26 and lower housing 30 are engaged (FIG. 11), the actuator housing engages the lower spring retainer 38 and thus reengages with the spring load of the biasing element 36. The lower spring retainer 38, when engaged with the actuator housing, may move along the pivot post 22 according to movement of the actuator housing, but may not drop or move along the pivot post 22 beyond a threshold point. For example, a tab or notch of the pivot post 22 may restrict the lower retainer 38 from moving beyond the point along the pivot post to allow the actuator housing to move out of engagement with the lower spring retainer 38 and the spring load from the spring 36. Thus, with the detent surfaces disengaged, the spring load may be through the lower spring retainer 38 to the pivot post 22 and base 21 to allow the housing to pivot about the pivot post 22 free of the spring load.

Although described herein as coupled to an exterior rearview mirror assembly, it should be understood that aspects of the actuator may be suitable for use with one or more other vehicular components. That is, the actuator may be configured to, when electrically operated, extend or rotate one or more components of the vehicle 11, such as the exterior rearview mirror, a charge port or fuel port cover, a headlamp or tail lamp or corresponding cover, a vehicle door, a vehicle hood or trunk, and/or a vehicular door handle.

For example, referring to FIG. 1, the vehicle 11 includes a door handle assembly or module or unit 40 that is mountable to a door 11a of the vehicle 11 and operable to release a latch mechanism of the door 11a to open the vehicle door. The vehicle door handle assembly 40 includes a base portion or bracket that is mountable to the vehicle door 11a and a handle or strap portion 42 that is movably or pivotally mounted to the bracket. When not in use, the handle portion 42 may be at an initial rest or recessed or non-use position where the handle portion 42 is at least partially received in the base portion so that an outer surface of the handle portion 42 is generally flush with or generally coplanar with (or protruding only slightly from or recessed slightly in) the outer surface of the base portion or the door panel, whereby the handle portion 42 is not readily usable by a user. The handle portion 42 is electromechanically pivotable or movable or laterally movable relative to the door 11a and the base portion to move to its ready or operational or grippable or graspable or person-operable position and is then graspable or grippable by a user where the handle portion 42 may be manually moved (such as via pulling by the user) to actuate or release the latch mechanism of the door to open the vehicle door. As described further below, an actuator 120 may be electrically operable to impart the pivotal movement of the handle portion 42 relative to the base portion.

The handle assembly 40 may comprise any suitable type of handle assembly, and the handle assembly and actuator may include or incorporate aspects of the door handle assemblies and actuators described in U.S. Pat. Nos. 8,786,401; 6,977,619; 7,407,203; 6,349,450; 6,550,103; 6,907,643; 8,801,245 and/or 8,333,492, and/or U.S. Publication Nos. US-2022-0018168; US-2022-0282534; US-2022-0341226; US-2010-0088855; US-2010-0007463 and/or US-2020/0102773, and/or U.S. patent application Ser. No. 18/359,114, filed Jul. 26, 2023 (Attorney Docket DON05 P4888), which are all hereby incorporated herein by reference in their entireties. Although shown as a strap type handle, the handle assembly may comprise any suitable type of vehicle door handle assembly, such as a paddle type vehicle door handle assembly (having a paddle or the like that may be pulled at to open the vehicle door) or other type of vehicle door handle assembly. Furthermore, aspects of the handle assembly 40 may be suitable for use with a liftgate handle assembly for a liftgate or tailgate of a vehicle.

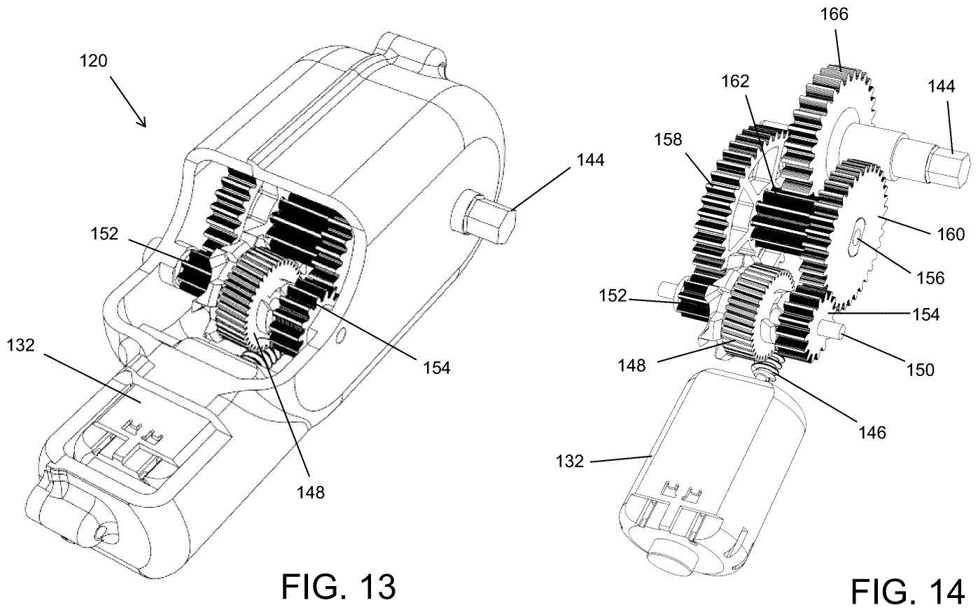

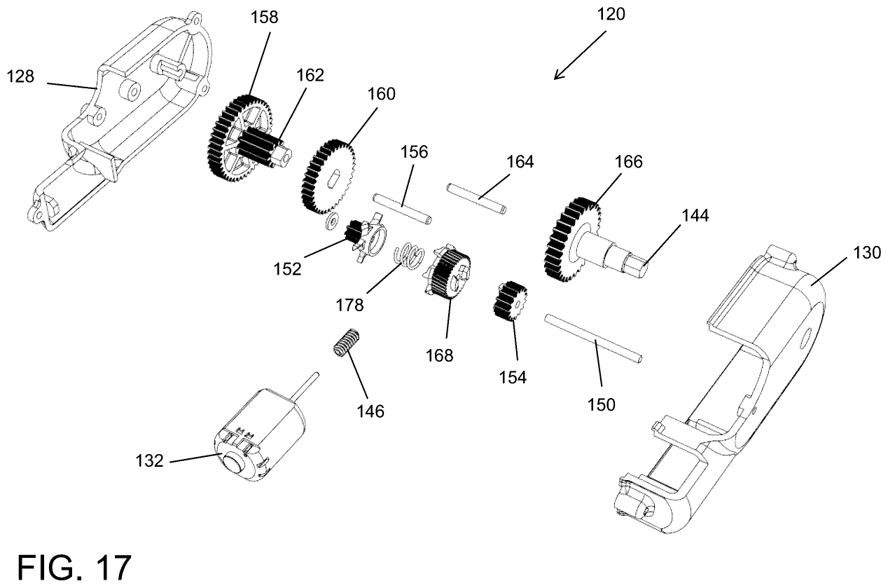

Referring to FIGS. 13-18A, the actuator 120 for the handle portion includes one or more electrically operable motors 132 that, when electrically operated, imparts movement of the handle portion (or other load coupled to the actuator) via an output element 144 of the actuator 120, such as a drive shaft (to provide a rotational movement output) or a plunger (to provide a linear movement output). The motor 132 rotatably drives a gear train to impart movement of the output element 144. Optionally, the actuator 120 may be operable to adjust the gear ratio of the gear train based on the torque load at the output element. For example, during normal operating conditions, the actuator 120 may experience a relatively lower torque load when extending the handle from the recessed position to the extended position. The actuator 120 may experience a relatively higher torque load when there is resistance to deployment of the handle, such as if there is ice or snow buildup at the exterior of the handle assembly. Thus, the actuator 120 may provide a higher speed output to quickly extend the handle when under lower torque loads and a higher gear ratio (i.e., lower speed output) when operating under greater torque loads, such as to provide an ice breaking function of the handle assembly. Adjustment of the gear ratio of the cam-operated automatic transmission actuator may be strictly mechanical in nature, without the use of control electronics or added motors to perform the adjustment.

In the illustrated example of FIGS. 13-18A, the electrically operable motor 132, when electrically operated, drives an output shaft that rotatably drives a gear train coupled to the output element 144. A worm gear 146 is disposed along the output shaft and rotatably driven when the motor 132 is operated. The worm gear 146 engages a helical portion 168 of a clutch gear element 148 to rotatably drive the clutch gear element 148. The clutch gear element 148 is disposed along, and rotates about, a first gear shaft 150 of the actuator 120 and engages one of a low speed drive gear 152 disposed along the first gear shaft 150 on a first side of the clutch gear element 148 or a high speed drive gear 154 disposed along the first gear shaft 150 on an opposite second side of the clutch gear element 148. As discussed further below, the clutch gear element 148 rotatably drives one of the low speed drive gear 152 or the high speed drive gear 154 based on the torque load at the output element 144.

The low speed drive gear 152 comprises a spur gear that engages and rotatably drives a first idler spur gear 158 disposed along a second gear shaft 156 of the actuator 120. The high speed drive gear 154 comprises a spur gear that engages and rotatably drives a second idler spur gear 160 disposed along the second gear shaft 156. The first and second idler gears are rotatably coupled to a third idler spur gear 162 disposed along the second gear shaft 156 between the first and second idler gears. The third idler gear 162 engages and rotatably drives an output gear 166 disposed along a third gear shaft 164 of the actuator 120, where the output gear 166 is rotatably coupled to the output element 144 and imparts rotational movement of the output element 144. Thus, when operating to provide a low speed, high torque output, output of the motor 132 travels along a first path of the gear train where the worm gear 146 drives the clutch gear element 148, which in turn drives the low speed gear element 152, and the low speed gear element 152 drives the first idler gear 158 that drives the output element 144 via the third idler gear 162 and the output gear 166. When operating to provide a high speed, low torque output, output of the motor 132 travels along a second path of the gear train where the worm gear 146 drives the clutch gear element 148, which in turn drives the high speed gear element 154, and the high speed gear element 154 drives the second idler gear 160 that drives the output element 144 via the third idler gear 162 and the output gear 166.

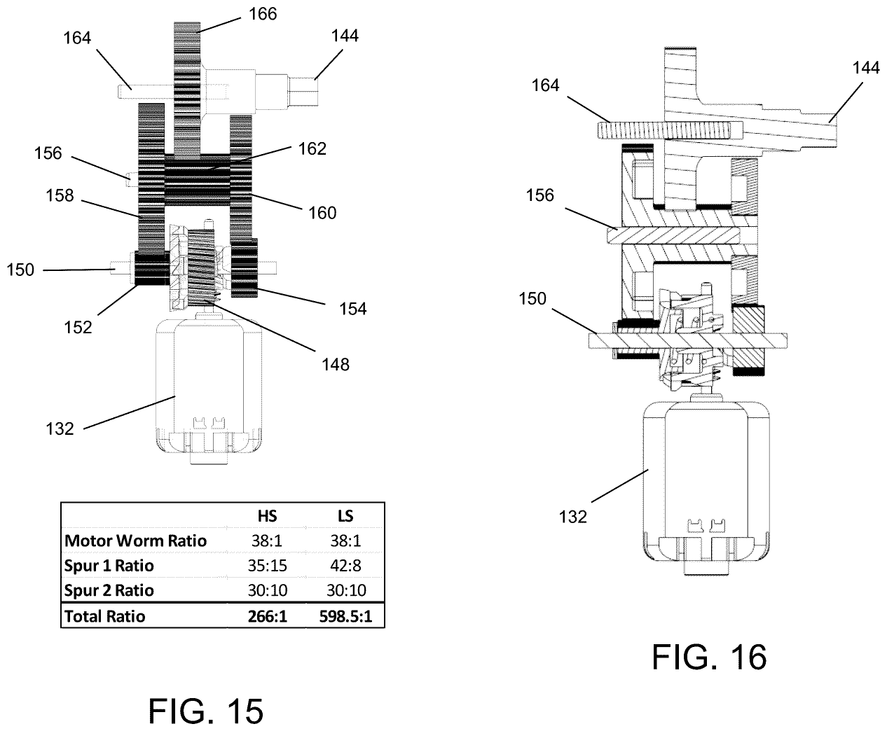

As shown in FIG. 15, the first path of the gear train (i.e., the low speed, high torque path) has a higher gear ratio than the second path of the gear train (i.e., the high speed, low torque path). Because both paths include the engagement of the worm gear 146 and the clutch gear element 148 and the engagement of the idler gears with the output gear 166, the difference in the gear ratios is driven by the different gear ratios of the low speed gear element 152 and the high speed gear element 154. For example, the motor worm ratio for both paths of the gear train (i.e., between the worm gear and the helical portion 168 of the clutch gear element 148) may be 38 to 1. The first spur ratio of the first path of the gear train (i.e., between the low speed gear element 152 and the first idler gear 158) may be 42 to 8, and the first spur ratio of the second path of the gear train (i.e., between the high speed gear element 154 and the second idler gear 160) may be 35 to 15. The second spur ratio of both paths of the gear train (i.e., between the third idler gear 162 and the output gear 166) may be 30 to 10. Thus, the total gear ratio for the first path of the gear train may be, for example, 598.5 to 1 and the total gear ratio for the second path of the gear train may be, for example, 266 to 1.

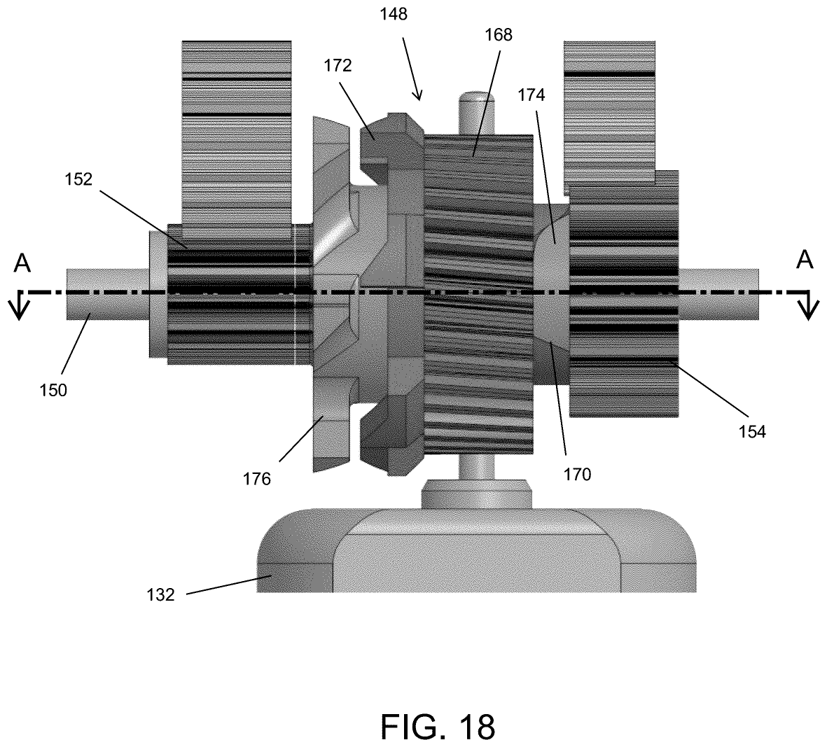

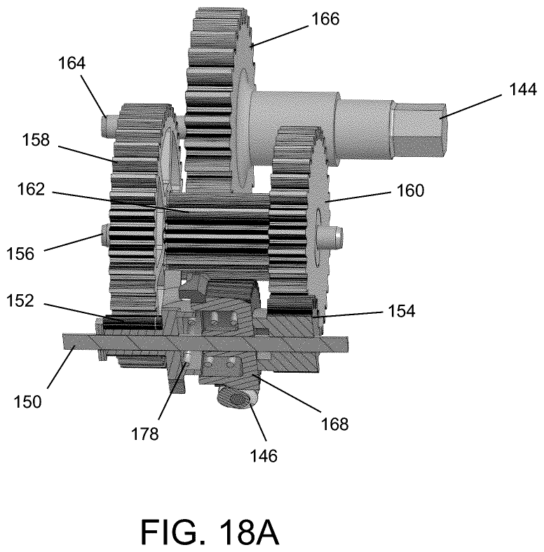

Referring to FIGS. 18 and 18A, the clutch gear element 148 automatically adjusts the actuator 120 between driving the output element 144 via the first path of the gear train and via the second path of the gear train. That is, the clutch gear element 148 alternately engages and rotatably drives the low speed gear element 152 and the high speed gear element 154. The clutch gear element 148 is movable along the first gear shaft 150 between the low speed gear element 152 and the high speed gear element 154.

At a first side of the helical portion 168 of the clutch gear element 148, one or more detents or a detent portion or surface 170 of the clutch gear element 148 are configured to engage one or more corresponding detents or a detent portion or surface 174 of the high speed gear element 154. When the respective detent surfaces of the clutch gear element 148 and the high speed gear element 154 are engaged, the clutch gear element 148 rotatably drives the high speed gear element 154.

At an opposite second side of the helical portion 168 of the clutch gear element 148, one or more teeth or protrusions 172 of the clutch gear element 148 are configured to engage one or more corresponding teeth or protrusions 176 of the low speed gear element 152 to form a dog clutch interface between the clutch gear element 148 and the low speed gear element 152. When the respective teeth of the clutch gear element 148 and the low speed gear element 152 are engaged, the clutch gear element 148 rotatably drives the low speed gear element 152.

A biasing element 178, such as a compression spring, is disposed along the first gear shaft 150 between the clutch gear element 148 and the low speed gear element 152 to bias the detent surface 170 of the clutch gear element 148 into engagement with the detent surface 174 of the high speed gear element 154. For example, the biasing element 178 is received within a portion of the clutch gear element 148 and within a portion of the low speed gear element 152 to be disposed radially inward of the helical portion 168 and the one or more teeth 172 of the clutch gear element 148 and the one or more teeth 176 of the low speed gear element 152.

With the biasing element 178 biasing the clutch gear element 148 into engagement with the high speed gear element 154, and thus biasing the clutch gear element 148 out of engagement with the low speed gear element 152, the actuator 120 provides the high speed, low torque output in a default state. When a high enough torque is experienced at the output element 144, such as when ice build-up is present at the handle portion, the torque causes the high speed gear element 154 to slip relative to the clutch gear element 148 and the detent surfaces of the high speed gear element 154 and the clutch gear element 148 travel along one another. As the detent surfaces of the high speed gear element 154 and the clutch gear element 148 move relative to one another, the clutch gear element 148 is moved along the first gear shaft 150 toward the low speed gear element 152 and against the biasing force of the biasing element 178. As the clutch gear element 148 moves along the first gear shaft 150, the detents 170 of the clutch gear element 148 disengage from the detents 174 of the high speed gear element 154 and the clutch gear element 148 stops rotatably driving the high speed gear element 154, and the one or more teeth 172 of the clutch gear element 148 engage the one or more teeth 176 of the low speed gear element 152 and the clutch gear element 148 begins rotatably driving the low speed gear element 152.

The dog clutch interface between the clutch gear element 148 and the low speed gear element 152 allows the teeth 172 of the clutch gear element 148 to engage the corresponding teeth 176 of the low speed gear element 152 as the clutch gear element 148 is rotating relative to the low speed gear element 152. With the dog clutch interface engaged, the low speed gear element 152 will not slip relative to the clutch gear element 148. As the torque load on the gear train decreases, such as when the handle portion breaks through the ice buildup or when the handle portion reaches the deployed position, the detents 170 of the clutch gear element 148 and the detents 174 of the high speed gear element 154 reengage and the dog clutch interface disengages.

The actuator 120 includes a housing that accommodates the motor 132 and the gear train between a first or lower housing portion 128 and a second or upper housing portion 130, with the output element 144 extending through an aperture or channel of the housing.

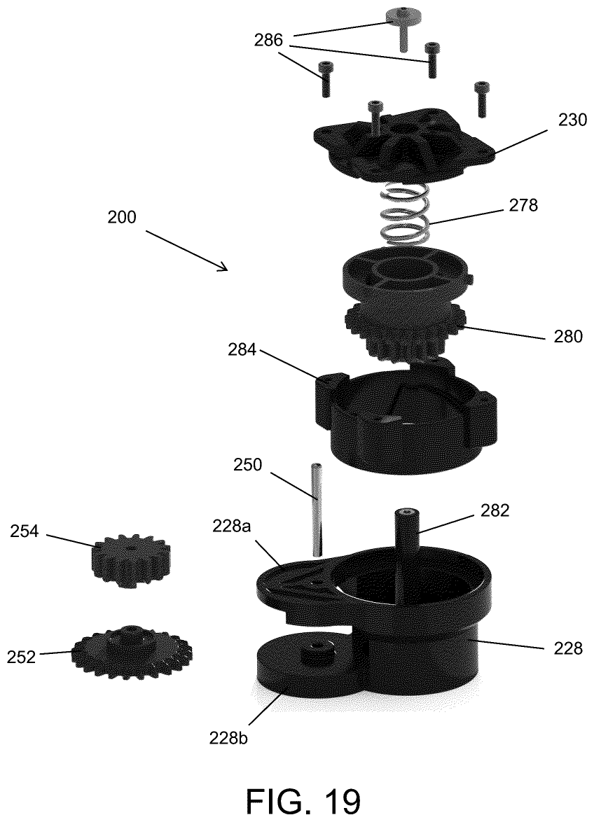

Referring to FIGS. 19-23, a clutch assembly 200 may be configured to receive a rotational input, such as from an electrically operable motor coupled to the clutch assembly 200, and provide a high speed, low torque output or provide a low speed, high torque output. As discussed further below, the clutch assembly 200 includes one or more gears with sharpened or ramped gear teeth to prevent gears from getting hung up as they pass each other and engage the mesh. Thus, the clutch assembly 200 provides a ramped variable torque clutch.

The clutch assembly 200 includes a low torque output gear 252 and a high torque output gear 254 that are disposed along a first gear shaft or pin 250. The low torque output gear 252 and the high torque output gear 254 may be adjacent one another or spaced along the pin 250 and the low torque output gear 252 may have a greater diameter than the high torque output gear 254. The output gears are rotatably driven by a detent gear 280 disposed along a shaft 282 of the clutch assembly 200, and the detent gear 280 is driven by the rotational input (e.g., electrically operable motor) coupled to the clutch assembly 200. The shaft 282 extends parallel to the pin 250 and alongside or adjacent the pin 250 so that the detent gear 280 rotates next to or adjacent the low torque output gear 252 and the high torque output gear 254. Output from the clutch assembly 200 may be provided via rotation of the pin 250 (such as if the pin 250 is rotationally coupled to the low torque output gear 252 and the high torque output gear 254 and rotates with the output gears) or via an output element driven by the low torque output gear 252 and/or high torque output gear 254.

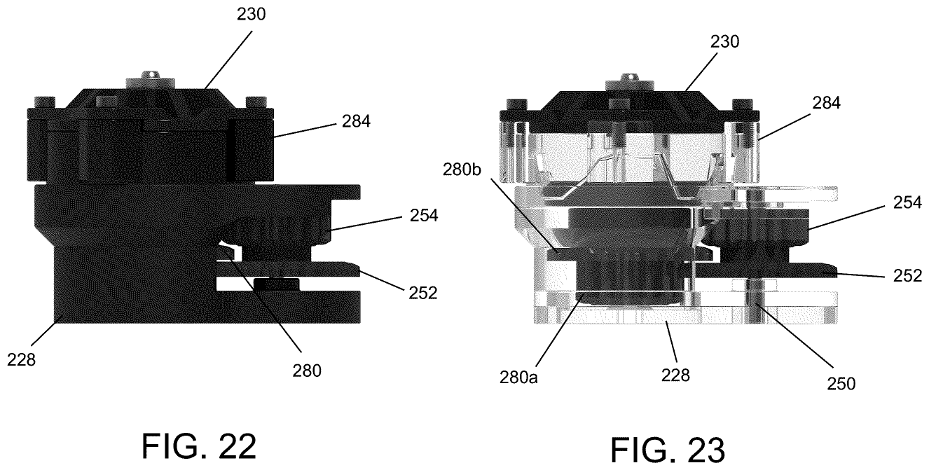

As shown in FIGS. 22 and 23, the detent gear 280 includes a first, smaller diameter portion 280a configured to engage the low torque output gear 252 and a second, larger diameter portion 280b configured to engage the high torque output gear 254. The first portion 280a and the second portion 280b of the detent gear 280 may be spaced from one another along the shaft 282 so that only one portion of the detent gear 280 may engage the corresponding one of the low torque output gear 252 and the high torque output gear 254 at a time. When the smaller diameter portion 280a drives the output gear 252, the clutch assembly 200 may provide the lower speed and greater torque output. When the larger diameter portion 280b drives the output gear 254, the clutch assembly may provide the higher speed and lower torque output. The respective gear ratios between the smaller diameter portion 280a and the output gear 252 and between the larger diameter portion 280b and the output gear 254 may be different from one another to provide different speed and torque outputs when engaged. Thus, adjusting the clutch assembly 200 between driving the output gear 252 and the output gear 254 may allow a motor operating at one speed to provide outputs at different speeds and torques.

An input element 284 is disposed along the shaft 282 and about the shaft 282 relative to the detent gear 280, where rotation of the input element 284 causes the detent gear 280 to translate along the shaft 282 relative to the low torque output gear 252 and the high torque output gear 254 to control engagement between the detent gear 280 and the output gears. The detent gear 280 may be disposed at least partially within, or extend along an interior portion of, the input element 284.

The clutch assembly 200 includes a housing 228 and a gear cap 230 that accommodate the low torque output gear 252, the high torque output gear 254, the detent gear 280, and the input element 284 between the housing 228 and gear cap 230. The shaft 282 may be integrally formed with the housing 228 and the pin 250 is spaced from and parallel to the shaft 282. The pin 250 extends between a lower flange 228a and an upper flange 228b of the housing 228, with the low torque output gear 252 and the high torque output gear 254 disposed between the lower flange 228a and the upper flange 228b. One or more fasteners, such as one or more threaded fasteners or screws 286 secure the gear cap 230 to the input element 284, and a fastener 286 received along the shaft 282 to couple the gear cap 230 to the housing 228 and allow the input element 284 and detent gear 280 to pivot about the shaft 282.

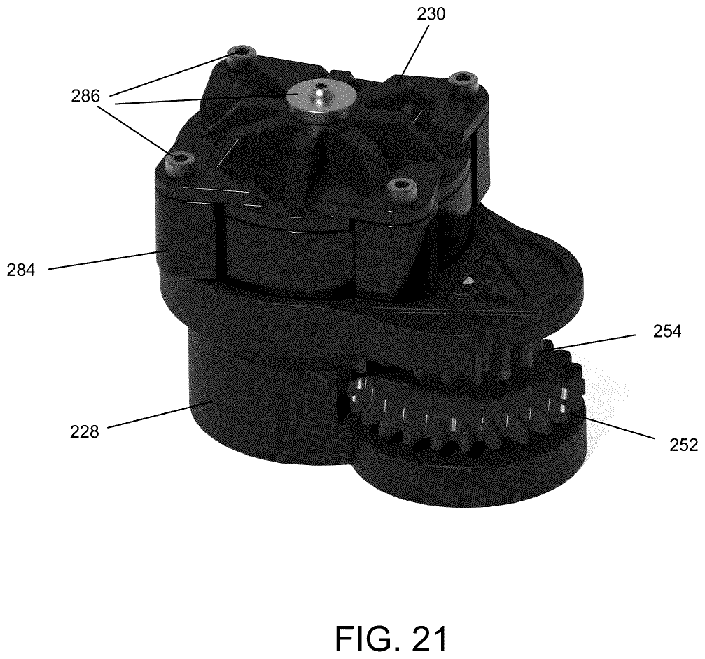

A biasing element 278, such as a compressing spring, is disposed between the gear cap 230 and the detent gear 280 and biases or urges the detent gear 280 and/or the input element 284 away from the gear cap 230 and toward the lower housing 228. The input element 284 may be adjustably movable along the shaft 282 to move the detent gear 280 along the shaft 282 and thus adjust engagement of the detent gear 280 between a low torque, high speed output (where the first portion 280a of the detent gear 280 engages the low torque output gear 252) and a high torque, low speed output (where the second portion 280b of the detent gear 280 engages the high torque output gear 254). For example, the input element 284 may be rotated (e.g., counterclockwise in FIG. 21) relative to the housing 228 to lower the detent gear 280 along the shaft 282 and transition from high speed output to high torque output. Further, the input element 284 may be rotated (e.g., clockwise in FIG. 21) relative to the housing 228 to raise the detent gear 280 along the shaft 282 and transition from high torque output to high speed output. The respective output gears may thus be coupled to a vehicular component, such as the mirror head or door handle assembly to provide the high speed or high torque output.

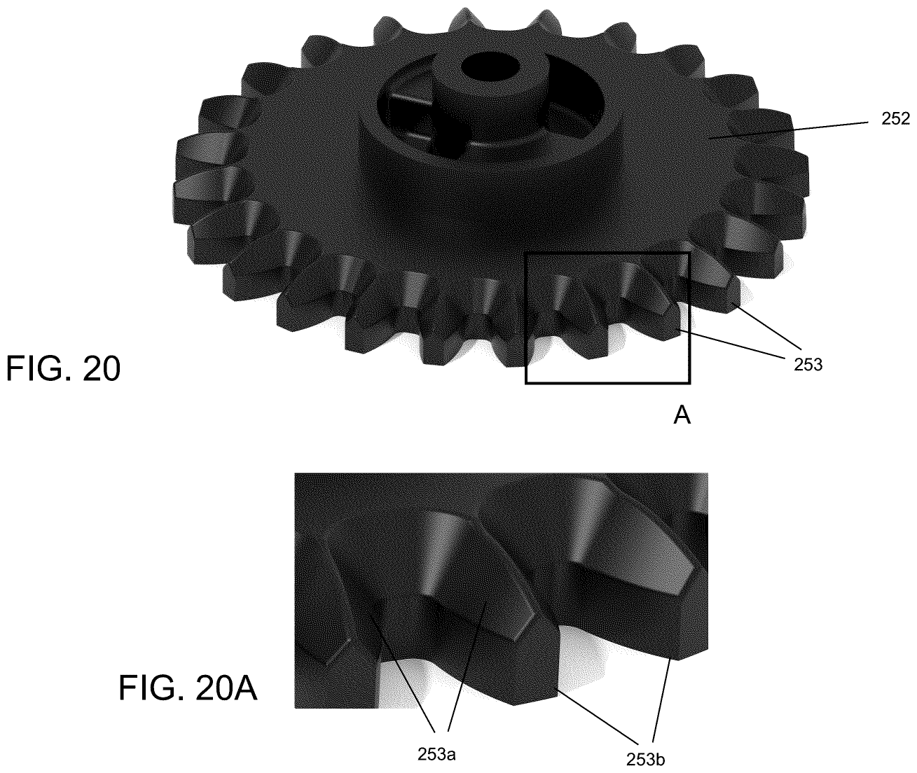

Moreover, and as shown in FIGS. 20 and 20A, the output gears (and optionally the detent gear) may have gear teeth with a sharpened edge or ramped edge on a side of the output gear that engages and disengages the detent gear to prevent the gears from getting hung up as they pass one another. In other words, the sharpened edges of the gears allow for a smoother transition from high speed to high torque output as the detent gear 280 raises and lowers into engagement with the low torque output gear 252 and the high torque output gear 254. For example, FIGS. 20 and 20A depict the low torque output gear 252, which includes gear teeth 253. Each respective gear tooth 253 of the low torque output gear 252 includes a sharpened or ramped edge portion 253a on a first side of the gear 252 and a flattened or squared edge portion 253b on a second side of the gear 252 so that respective teeth of the detent gear 280 may more easily pass along the sharpened edge portion 253a of the gear 252 to engage the squared edge portion 253b as the detent gear 280 axially moves into engagement with the low torque output gear 252.

The actuator may be configured to turn off or stall the electric motor when the mirror head or door handle (or other suitable load) reaches a hard stop. However, an audible click may occur when the motor shaft rebounds when power is removed from the actuator. To quiet or reduce or eliminate the audible click, the rebound is slowed. For example, the motor torque may be gradually reduced to slow the rebound rather than instantaneously turning the motor off.

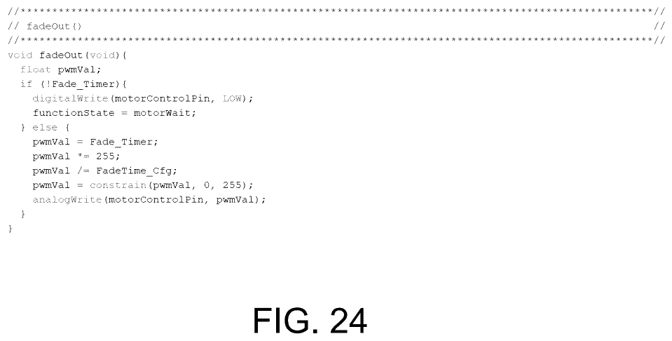

To achieve the gradual reduction in motor torque, the control function for the actuator may include a SmartSODuino with an additional function added (FIG. 24). Thus, the operation of the actuator may be adjusted without new or different components, which allows the system to vary the operational parameters during operation and allows for changing between the soft-shut-off and conventional algorithms for testing and demonstration.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mirror head accommodating a mirror reflective element;
a mounting base configured for mounting the vehicular exterior rearview mirror assembly at a side of a vehicle equipped with the vehicular exterior rearview mirror assembly;
wherein, with the vehicular exterior rearview mirror assembly mounted at the side of the vehicle, the mirror head is movable relative to the mounting base between at least (i) an extended position, where the mirror head is extended outward from the side of the vehicle so that the mirror reflective element is positioned to provide a rearward view at the side of the vehicle to a driver of the vehicle, and (ii) a folded position, where the mirror head is moved inward from the extended position toward the side of the vehicle;
an electrically operable actuator, wherein, with the vehicular exterior rearview mirror assembly mounted at the side of the vehicle, the actuator is electrically operable to move the mirror head relative to the mounting base between the folded position and the extended position;
wherein the actuator comprises a base portion that attaches at the mounting base and a pivot tube that extends from the base portion of the actuator;
wherein the pivot tube extends through an output gear of the actuator and a housing of the actuator;
wherein the mirror head and the housing of the actuator, when the actuator is electrically operated, move together and in tandem about a longitudinal axis of the pivot tube of the actuator;
wherein the output gear is rotatably fixed relative to the base portion of the actuator, and wherein the housing of the actuator, when the actuator is electrically operated, (i) pivots about the output gear as the housing of the actuator moves about the longitudinal axis of the pivot tube;
wherein the actuator comprises a biasing element that releasably retains the actuator in at least one detent state of the actuator;
wherein the output gear comprises a plurality of detents that, when the actuator is in the at least one detent state of the actuator, engage a corresponding plurality of detents of the housing of the actuator;
wherein, as the mirror head moves between the extended position and the folded position, the plurality of detents of the housing of the actuator disengage from the plurality of detents of the output gear;
wherein, with the plurality of detents of the output gear engaged with the plurality of detents of the housing of the actuator, the biasing element biases through the housing of the actuator and the output gear to the base portion of the actuator to releasably retain the actuator in the at least one detent state of the actuator; and
wherein, with the plurality of detents of the housing of the actuator disengaged from the plurality of detents of the output gear, the biasing element does not bias through the housing of the actuator and the output gear.

2. The vehicular exterior rearview mirror assembly of claim 1, wherein, with the plurality of detents of the housing of the actuator disengaged from the plurality of detents of the output gear, the output gear and the housing of the actuator move in a direction parallel to the longitudinal axis of the pivot tube toward the base portion.

3. The vehicular exterior rearview mirror assembly of claim 1, wherein, with the plurality of detents of the output gear engaged with the plurality of detents of the housing of the actuator, the biasing element engages the housing of the actuator.

4. The vehicular exterior rearview mirror assembly of claim 1, wherein, with the plurality of detents of the housing of the actuator disengaged from the plurality of detents of the output gear, the biasing element does not engage the housing of the actuator.

5. The vehicular exterior rearview mirror assembly of claim 1, wherein a retainer is disposed between the biasing element and the housing of the actuator.

6. The vehicular exterior rearview mirror assembly of claim 5, wherein, with the plurality of detents of the output gear engaged with the plurality of detents of the housing of the actuator, the biasing element biases through the retainer, the housing of the actuator and the output gear to the base portion of the actuator to releasably retain the actuator in the at least one detent state of the actuator.

7. The vehicular exterior rearview mirror assembly of claim 5, wherein, with the plurality of detents of the housing of the actuator disengaged from the plurality of detents of the output gear, the biasing element biases through the retainer and the pivot tube to the base portion of the actuator.

8. The vehicular exterior rearview mirror assembly of claim 1, wherein the biasing element is disposed between the housing of the actuator and an upper end of the pivot tube.

9. A vehicular exterior door handle assembly, the vehicular exterior door handle assembly comprising:
a base portion configured for mounting the vehicular exterior door handle assembly at a door of a vehicle equipped with the vehicular exterior door handle assembly;
a handle portion mounted at the base portion, wherein the handle portion includes a grasping portion;
wherein, with the vehicular exterior door handle assembly mounted at the door of the vehicle, the handle portion is movable relative to the base portion between (i) a recessed position, where the grasping portion of the handle portion is at least partially recessed at the base portion, and (ii) a deployed position, where the grasping portion of the handle portion protrudes outward from the base portion so as to be graspable by a user;
an actuator, wherein the actuator comprises (i) an electrically operable motor, (ii) an output element mechanically coupled to the handle portion and (iii) a drive element coupled to the output element;
wherein the actuator is operable to move the handle portion between the recessed position and the deployed position
wherein the actuator, when the electrically operable motor is electrically operated, rotatably drives the drive element to impart rotational movement of the output element to move the handle portion between the recessed position and the deployed position;
wherein the drive element comprises (i) a lower torque output gear and (ii) a higher torque output gear, and wherein a gear ratio of the lower torque output gear to the output element is greater than a gear ratio of the higher torque output gear to the output element;
wherein, when the actuator rotatably drives the lower torque output gear with the lower torque output gear engaged with the output element, a torque load at the output element is through the lower torque output gear to the electrically operable motor, and wherein, when the actuator rotatably drives the higher torque output gear with the higher torque output gear engaged with the output element, the torque load at the output element is through the higher torque output gear to the electrically operable motor and is not through the lower torque output gear; and
wherein, when the electrically operable motor is electrically operated, and based on the torque load at the output element being greater than a threshold torque load, the actuator rotatably drives the higher torque output gear with the higher torque output gear engaged with the output element to impart rotational movement of the output element.

10. The vehicular exterior door handle assembly of claim 9, wherein, when the electrically operable motor is electrically operated, and based on the torque load at the output element being less than the threshold torque load, the actuator rotatably drives the lower torque output gear with the lower torque output gear engaged with the output element to impart rotational movement of the output element.

11. The vehicular exterior door handle assembly of claim 9, wherein the actuator comprises a clutch gear element that selectably engages one of the lower torque output gear and the higher torque output gear, and wherein, when the electrically operable motor is electrically operated, the actuator rotatably drives the clutch gear element to rotatably drive the engaged one of the lower torque output gear and the higher torque output gear.

12. The vehicular exterior door handle assembly of claim 11, wherein the clutch gear element, when the torque load at the output element is less than the threshold torque load, engages the lower torque output gear, and wherein the clutch gear element, when the torque load at the output element is greater than the threshold torque load, engages the higher torque output gear.

13. The vehicular exterior door handle assembly of claim 11, wherein a biasing element biases the clutch gear element toward engagement with the lower torque output gear.

14. The vehicular exterior door handle assembly of claim 13, wherein the clutch gear element, as the torque load at the output element increases, is urged away from engagement with the lower torque output gear and toward engagement with the higher torque output gear.

15. The vehicular exterior door handle assembly of claim 11, wherein the clutch gear element comprises (i) a detent surface configured to engage a corresponding detent surface of the lower torque output gear, and (ii) a dog clutch surface configured to engage a corresponding dog clutch surface of the higher torque output gear.

16. The vehicular exterior door handle assembly of claim 9, wherein, when the actuator rotatably drives the lower torque output gear with the lower torque output gear engaged with the output element, the torque load at the output element is not through the higher torque output gear.

17. A vehicular exterior rearview mirror assembly, the vehicular exterior rearview mirror assembly comprising:
a mirror head accommodating a mirror reflective element;
a mounting base configured for mounting the vehicular exterior rearview mirror assembly at a side of a vehicle equipped with the vehicular exterior rearview mirror assembly;
wherein, with the vehicular exterior rearview mirror assembly mounted at the side of the vehicle, the mirror head is movable relative to the mounting base between at least (i) an extended position, where the mirror head is extended outward from the side of the vehicle so that the mirror reflective element is positioned to provide a rearward view at the side of the vehicle to a driver of the vehicle, and (ii) a folded position, where the mirror head is moved inward from the extended position toward the side of the vehicle;
an electrically operable actuator, wherein, with the vehicular exterior rearview mirror assembly mounted at the side of the vehicle, the actuator is electrically operable to move the mirror head relative to the mounting base between the folded position and the extended position;
wherein the actuator comprises a base portion that attaches at the mounting base and a pivot tube that extends from the base portion of the actuator;
wherein the pivot tube extends through an output gear of the actuator and a housing of the actuator;
wherein the mirror head and the housing of the actuator, when the actuator is electrically operated, move together and in tandem about a longitudinal axis of the pivot tube of the actuator;
wherein the output gear is rotatably fixed relative to the base portion of the actuator, and wherein the housing of the actuator, when the actuator is electrically operated, (i) pivots about the output gear as the housing of the actuator moves about the longitudinal axis of the pivot tube;
wherein the actuator comprises a biasing element that releasably retains the actuator in at least one detent state of the actuator, and wherein a retainer is disposed between the biasing element and the housing of the actuator;
wherein the output gear comprises a plurality of detents that, when the actuator is in the at least one detent state of the actuator, engage a corresponding plurality of detents of the housing of the actuator;
wherein, as the mirror head moves between the extended position and the folded position, the plurality of detents of the housing of the actuator disengage from the plurality of detents of the output gear;
wherein, with the plurality of detents of the output gear engaged with the plurality of detents of the housing of the actuator, the biasing element biases through the retainer, the housing of the actuator and the output gear to the base portion of the actuator to releasably retain the actuator in the at least one detent state of the actuator; and
wherein, with the plurality of detents of the housing of the actuator disengaged from the plurality of detents of the output gear, (i) the output gear and the housing of the actuator move in a direction parallel to the longitudinal axis of the pivot tube toward the base portion, (ii) the biasing element biases through the retainer and the pivot tube to the base portion of the actuator and (iii) the biasing element does not bias through the housing of the actuator and the output gear.

18. The vehicular exterior rearview mirror assembly of claim 17, wherein, with the plurality of detents of the output gear engaged with the plurality of detents of the housing of the actuator, the retainer engages the housing of the actuator.

19. The vehicular exterior rearview mirror assembly of claim 17, wherein, with the plurality of detents of the housing of the actuator disengaged from the plurality of detents of the output gear, the retainer does not engage the housing of the actuator.

20. The vehicular exterior rearview mirror assembly of claim 17, wherein the biasing element is disposed between the retainer and an upper end of the pivot tube.
